(19) United States
(12) Patent Application Publication
(10) Pub. No.: US 2026/0194477 A1
(43) Pub. Date: Jul. 9, 2026

(54) MATERIAL CHARACTERIZATION OF CRYSTALLINE SILICON SOLAR PHOTOVOLTAIC PANELS USING X-RAY FLUORESCENCE

(71) Applicant: Dwarak Ravikumar, Gilbert, AZ (US)

(72) Inventor: Dwarak Ravikumar, Gilbert, AZ (US)

(21) Appl. No.: 19/431,201

(22) Filed: Dec. 23, 2025

Related U.S. Application Data
(60) Provisional application No. 63/741,649, filed on Jan. 3, 2025.

(51) Int. Cl. G01N 23/223

(52) U.S. Cl. CPC G01N 23/223; G01N 2223/301

(57) ABSTRACT

Assessing concentrations of components in a photovoltaic panel includes exposing a region of a photovoltaic panel to irradiation from an X-ray fluorescence spectrometer. Exposing the region of the photovoltaic panel ionizes a multiplicity of atoms in the region, and each atom of the multiplicity of atoms corresponds to a chemical component. The radiation emitted by the multiplicity of atoms is analyzed to assess a concentration of each chemical component in the region.

### CROSS-REFERENCE TO RELATED APPLICATION

This application claims the benefit of U.S. patent application Ser. No. 63/741,649 filed on Jan. 3, 2025, which is incorporated by reference herein in its entirety.

### TECHNICAL FIELD

This invention relates to systems, devices, and methods for assessment of the concentrations of various components of spent crystalline silicon solar photovoltaic panels using X-ray fluorescence.

### BACKGROUND

A spent crystalline silicon photovoltaic panel, which has reached end-of-service-life, contains bulk materials such as glass and silicon, precious materials like silver, and toxic materials like lead.

### SUMMARY

This disclosure describes systems, devices, and methods for assessment of the concentrations of various components (e.g., glass, silicon, lead, silver, copper, tin, and aluminum) of spent crystalline silicon solar photovoltaic panels using X-ray fluorescence. The X-ray fluorescence systems and devices can be portable (e.g., hand-held). The spent crystalline solar photovoltaic panels can be of any design or manufacturer. This technology can be advantageous for transporters to determine if the spent crystalline silicon photovoltaic panels can be transported as hazardous or non-hazardous waste. This technology can be also advantageous to recyclers to estimate the revenues that can be realized by selling the precious materials recovered from the spent crystalline silicon photovoltaic panels.

In a first general aspect, assessing concentrations of components in a photovoltaic panel includes exposing a region of a photovoltaic panel to irradiation from an X-ray fluorescence spectrometer, thereby ionizing a multiplicity of atoms in the region, wherein each atom corresponds to a chemical component, and analyzing radiation emitted by the multiplicity of atoms to assess a concentration of each chemical component in the region.

Implementations of the first general aspect can include one or more of the following features.

In some cases, the photovoltaic panel includes silicon. The photovoltaic panel can include crystalline silicon. In some implementations, the photovoltaic panel is a spent photovoltaic panel. The X-ray fluorescence spectrometer can be portable. In some cases, the X-ray fluorescence spectrometer is configured to be handheld. In some implementations, the chemical component includes one or more of silicon, lead, silver, copper, tin, and aluminum. The concentration can include a percentage of the chemical component by mass of the total photovoltaic panel mass. In some cases, the first general aspect further includes exposing a multiplicity of additional regions of the photovoltaic panel to the X-ray fluorescence spectrometer. In some implementations, the concentration includes an average percentage of the chemical component by mass of the total photovoltaic panel mass.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a flow chart showing operations in a process for assessing concentrations of components in a photovoltaic panel.

### DETAILED DESCRIPTION

Crystalline silicon photovoltaic panels contain bulk materials (e.g., glass, silicon, aluminum), toxic materials (e.g., lead, tin, and copper), and precious materials (e.g., silver). The material content of a crystalline silicon photovoltaic panel varies based on the design of the panel. For example, a crystalline silicon photovoltaic panel that was manufactured with lead-based solders will have a higher lead concentration than a crystalline silicon photovoltaic panel manufactured with a non-lead-based solder. Lead content of a crystalline silicon photovoltaic panel is one of the factors that determine whether the spent crystalline silicon photovoltaic panel is categorized as hazardous waste.

When a crystalline silicon photovoltaic panel reaches end-of-service-life, it is typically transported from the site of de-installation to a recycling location. Information such as the concentration of toxic materials contained in the crystalline silicon photovoltaic panel is typically requested by the transporter to assess whether the crystalline silicon photovoltaic panel is transported as hazardous waste or non-hazardous waste according to regulatory requirements. Similarly, a recycler of the spent photovoltaic panel typically requests a measure of the concentration of the contained toxic and precious materials to estimate the profitability from recycling the crystalline silicon photovoltaic panel based on the costs of managing toxic materials and the revenue from recovering precious materials.

This disclosure describes methods for assessment of the concentration of various components of spent crystalline silicon solar photovoltaic panels using X-ray fluorescence. In some examples, the concentration is assessed as percentage by mass of the total photovoltaic panel mass. Examples of the various components include glass, silicon, lead, silver, copper, tin, and aluminum. The X-ray fluorescence systems and devices can be a portable X-ray fluorescence spectrometer (e.g., hand-held). The spent crystalline solar photovoltaic panels can be of any design or manufacturer. An individual responsible for transporting or recycling the crystalline silicon photovoltaic panel can use the X-ray fluorescence spectrometer to assess the glass, silicon, lead, silver, copper, tin, or aluminum concentration in a spent crystalline silicon photovoltaic panel. In some examples, the individual holds the X-ray fluorescence spectrometer upright against the crystalline silicon photovoltaic panel to get a reading of the concentration readings of lead, silver, copper, tin, or aluminum in a spent crystalline silicon photovoltaic panel. Implementations also include selection of specific parts of a spent crystalline silicon photovoltaic panel to be targeted by the X-ray fluorescence spectrometer to obtain the desired results, as well as a length of time needed for the assessment to accurately determine the material concentrations.

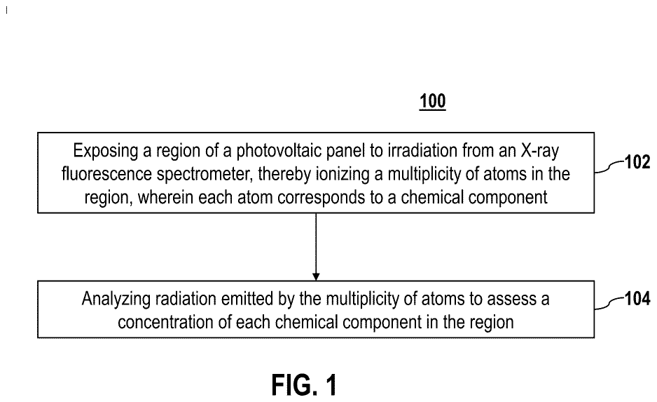

FIG. 1 is a flow chart showing operations in a process 100 for assessing concentrations of components in a photovoltaic panel. In 102, a region of a photovoltaic panel is exposed to irradiation from an X-ray fluorescence spectrometer, thereby ionizing a multiplicity of atoms in the region. In some implementations, the region of the photovoltaic panel is exposed to irradiation for a length of time between 15 seconds and 2 minutes (e.g., 30 seconds, 35 seconds, 40 seconds, or 45 seconds). Each atom corresponds to a chemical component. In 104, radiation emitted by the multiplicity of atoms are analyzed to assess a concentration of each chemical component in the region.

In some cases, the photovoltaic panel includes silicon. In some implementations, the photovoltaic panel includes crystalline silicon. The photovoltaic panel can be a spent photovoltaic panel. The X-ray fluorescence spectrometer can be portable. In some cases, the X-ray fluorescence spectrometer is configured to be handheld. The chemical component can include one or more of silicon, lead, silver, copper tin, and aluminum. In some cases, the concentration includes a percentage of the chemical component by mass of the total photovoltaic panel mass. The process 100 further includes exposing a multiplicity of additional regions of the photovoltaic panel to the X-ray fluorescence spectrometer. In some implementations, the additional regions of the photovoltaic panel are exposed to irradiation for a length of time between 15 seconds to 2 minutes (e.g., 30 seconds, 35 seconds, 40 seconds, or 45 seconds). In some cases, the concentration includes an average percentage of the chemical component by mass of the total photovoltaic mass.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of assessing concentrations of components in a photovoltaic panel, the method comprising:
exposing a region of a photovoltaic panel to irradiation from an X-ray fluorescence spectrometer, thereby ionizing a multiplicity of atoms in the region, wherein each atom corresponds to a chemical component; and
analyzing radiation emitted by the multiplicity of atoms to assess a concentration of each chemical component in the region.

2. The method of claim 1, wherein the photovoltaic panel comprises silicon.

3. The method of claim 2, wherein the photovoltaic panel comprises crystalline silicon.

4. The method of claim 1, wherein the photovoltaic panel is a spent photovoltaic panel.

5. The method of claim 1, wherein the X-ray fluorescence spectrometer is portable.

6. The method of claim 5, wherein the X-ray fluorescence spectrometer is configured to be handheld.

7. The method of claim 1, wherein the chemical component comprises one or more of silicon, lead, silver, copper, tin, and aluminum.

8. The method of claim 1, wherein the concentration comprises a percentage of the chemical component by mass of the total photovoltaic panel mass.

9. The method of claim 1, further comprising exposing a multiplicity of additional regions of the photovoltaic panel to the X-ray fluorescence spectrometer.

10. The method of claim 9, wherein the concentration comprises an average percentage of the chemical component by mass of the total photovoltaic panel mass.
